(19) United States
(12) Patent Application Publication
(10) Pub. No.: US 2022/0259520 A9
(43) Pub. Date: Aug. 18, 2022

(54) SAMPLER FOR A SCENTED WAXY CANDLE AND PROCESS

(71) Applicant: AKI, INC., Chattanooga, TN (US)

(72) Inventors: Mickael Devassine, Ooltewah, TN (US); Amal Brohmi, Chattanooga, TN (US); Catholyn T. Griffiths, Phoenix, MD (US); Joshua M. Dozier, Lafayette, GA (US); Hrazhyna Devassine, Ooltewah, TN (US)

(73) Assignee: AKI, INC., CHATTANOOGA, TN (US)

(21) Appl. No.: 16/988,838

(22) Filed: Aug. 10, 2020

Related U.S. Application Data
(60) Provisional application No. 62/884,820, filed on Aug. 9, 2019.

(51) Int. Cl. C11C 5/00

(52) U.S. Cl. CPC C11C 5/008; C11C 5/002

(57) ABSTRACT

A sampler is presented for a sample of a scented, waxy candle material. The scented, waxy material is melted and may be diluted with compatible additives and/or liquid (organic oil or hydrocarbon), before being layered to a face of a bottom layer. A top layer (3) is applied directly over the sample and can be adhered to the bottom layer to form a seal. In another embodiment a peripheral seal, is formed between the top and the bottom layers. The seal is separable by a user pulling on a tab a portion of the top layer to expose the face of the sample to the atmosphere allowing the volatile molecules present in the candle to be released. With a repositionable glue as a seal, the top layer can be replaced to prevent further release of volatile molecules. A method is also shown for making the sample.

### CROSS-REFERENCE TO RELATED APPLICATION

The present application claims priority to U.S. Provisional Patent Application Ser. No. 62,884,820 filed Aug. 9, 2019 which is hereby incorporated herein by reference in entirety for all purposes.

### BACKGROUND

Scented candles are a popular way to create a pleasant ambiance at home. Scents such as lavender, jasmine, and sandalwood can be relaxing and invigorating. During the holidays, many people find the warm glow and aroma of pine, gingerbread, or cinnamon to make a room more festive and inviting. With such a high number of scented candles available to the consumer, the function of the invention will allow the consumer to easily identify the fragrance of interest. The invention allows for a faithful rendition of the perfumed candle through the direct use of the scented candle.

The U.S. Pat. No. 5,439,172 describes a planar sampler for a liquid volatile material such as a perfume.

A sampler for lipstick is related in the U.S. Pat. No. 5,562,112. a coated cover stock, upon which a lipstick is screen printed in any desired pattern. A perimeter adhesive is applied to the coated face stock and a clear cover sheet is laminated over the lipstick. The cover serves to prevent offset and projects the image of a clean, sanitary product.

The U.S. Pat. No. 6,282,652 reported a fluid sampler including a transparent composite laminate sealed with a composite laminate having a foil barrier layer.

A fluid sampler pouch with internal supportive structure within a cavity allowing the peel seal to withstand compressive force is described in the U.S. Pat. No. 6,326,069.

### SUMMARY

A sampler for a fragrance candle material sample includes the following:
1. A sample of a fragrance candle material applied directly to a selected area of an upper surface of a vapor barrier bottom layer.
2. A vapor barrier top layer applied directly, without an intermediate layer, over the sample and at least a selected area of the upper surface of the vapor barrier of the bottom layer.
3. A seal between at least the periphery of the bottom and top layers forming a vapor barrier enclosure containing the sample. A user can separate at least part of said top layer from the bottom layer to expose at least part of the sample to the atmosphere and allow the volatile molecules in the sample to be released. By using repositionable glue as the sealant, the top layer can be designed to again be sealed to the bottom layer to prevent further release of the volatile molecules in the sample.

Also disclosed is a process for manufacturing the disclosed sampler includes the following:
1. Applying a sample of a melted candle material directly to a selected area of an upper surface of a vapor barrier bottom layer. The sample of the fragrance candle material may be diluted with compatible additives such as waxes (paraffin wax, soy wax . . . ) and solvents (isopropyl myristate, isopropyl palmitate, dioctyl adipate . . . ) to help the volatile molecules to be released when the sampler is opened, and to adjust the hardness and melting point of the candle wax leading to a better application of the wax on the said bottom layer. A stabilizer and/or colored substance may be added to the mixing to stabilize and/or color the mixing the sample.
2. Applying a vapor barrier top layer over at least said selected area of said first face of the bottom layer.
3. Forming a vapor barrier seal between the bottom and top layers to form a vapor barrier enclosure for the volatile molecules.

The sample of melted candle material is applied to an intermediate pad and transferred to the base layer. The pad may be in any shape (disc, rectangle, candle . . . ). The candle wax may be colored with pigments.

The sample of scented wax is applied to a substantially central area of a substantially vapor impermeable plastic or laminate sheet bottom layer, which may be in the form of disc, rounded rectangle or other shape. The top layer is typically a similar shape as the bottom layer of the same material or another plastic or laminate sheet material. The seal between the bottom and top layers may be formed by surface to surface contact adhesion between the opposed faces of the bottom and top layers or by an adhesive or other bonding (such as heat-sealing, Radio-Frequency sealing) between the opposed faces of the bottom and top layers. Preferably, such a seal is formed around the periphery of the contacting opposed faces of the bottom and top layers and is conveniently radially inset from the edges of the layers over at least part of its length to provide an unbonded tab or edge which can be gripped by the user to separate the bottom and top layers when it is desired.

The slimness and flexibility of the sampler allow for placement upon or between pages of magazines, flyers, newspapers or postcards. The sampler is used as an advertisement allowing the reader to discover the scents of the candle.

### BRIEF DESCRIPTION OF DRAWINGS

FIG. 1 is a vertical cross-section view through the sampler.

FIG. 2 is a top view of a sampler.

FIG. 3 shows a roller applicator of the scented candle material.

FIG. 4 depicts a process for the manufacture of a sampler shown in FIG. 1.

FIG. 5 is a vertical cross-section view through another embodiment of a sampler.

FIG. 6 is a vertical cross-section view through another embodiment of a sampler.

### PARTS

1 bottom barrier layer

2 sample of candle wax

3 top barrier layer

4 adhesive

5 area beyond sample

6 temperature-controlled bath

7 adhesive on bottom of sampler

8 hot air blower

9 pad

10 roller applicator

11 hot air blower

12 roller applicator

13 NOT USED

14 pressure roller

15 printing unit

16 hot air blower

17 UV light

18 air blade cutter

19 sampler

### DETAILED DESCRIPTION

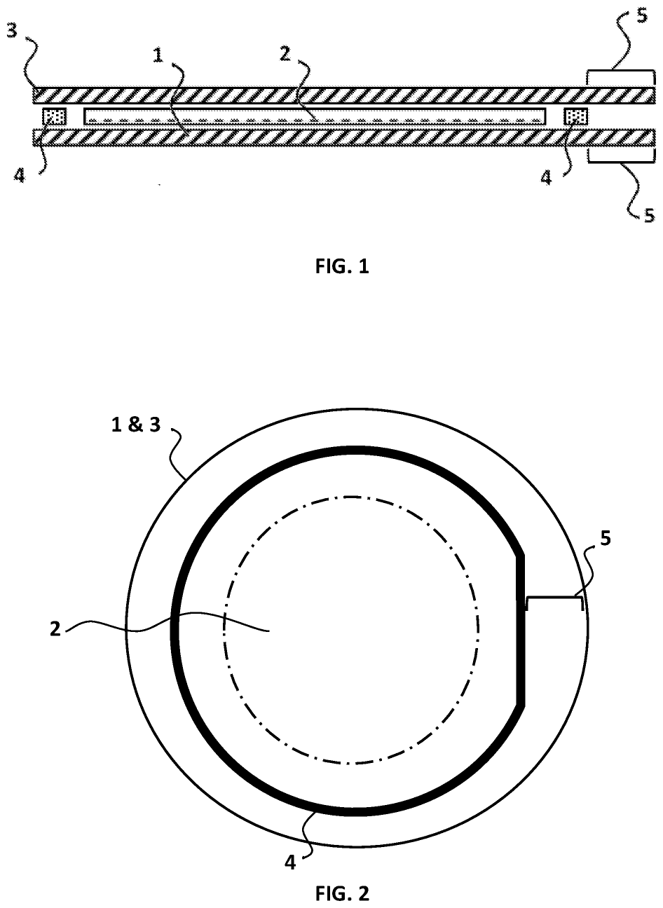

The sampler disclosed is shown in FIGS. 1 & 2. It comprises a bottom barrier layer (1) on which is applied the pre-melted and diluted scented candle wax (2) and over which is applied a top barrier layer (3). In one embodiment a seal ring of adhesive (4) or other sealing bond is placed around the periphery of the bottom layer (1) to keep in place the top layer to avoid the release of odorous, volatile molecules. In another embodiment the top (3) and bottom (1) layers may be sealed together by heating or by another process or created to enable an auto adhesive utilizing their surface energy properties (FIG. 6). In these cases, the adhesive ring (4) is not necessary.

The bottom layer (1) can be made from odorless, plastic materials which are not degraded or dissolved by the sample candle materials to be applied to them, and which will present good barrier properties. An example of those materials are polyolefins, such as polyethylenes, polypropylenes, or polyester. Polymers for use in the bottom or top layer are polyester polymers, e.g. polyethyleneterephtalate. The bottom layer may be a laminate of two or more different materials. For example, a polyethylene or an amorphous polyester upper layer with a polyester under layer, bonded together by an adhesive interface such as a polyacrylic adhesive. This kind of laminate may be selected if a peelable heat-seal is desired.

The bottom layer may be treated (corona discharge) or coated in order to enhance the adhesion of the sample of scented candle material to the surface of the polymeric bottom layer material.

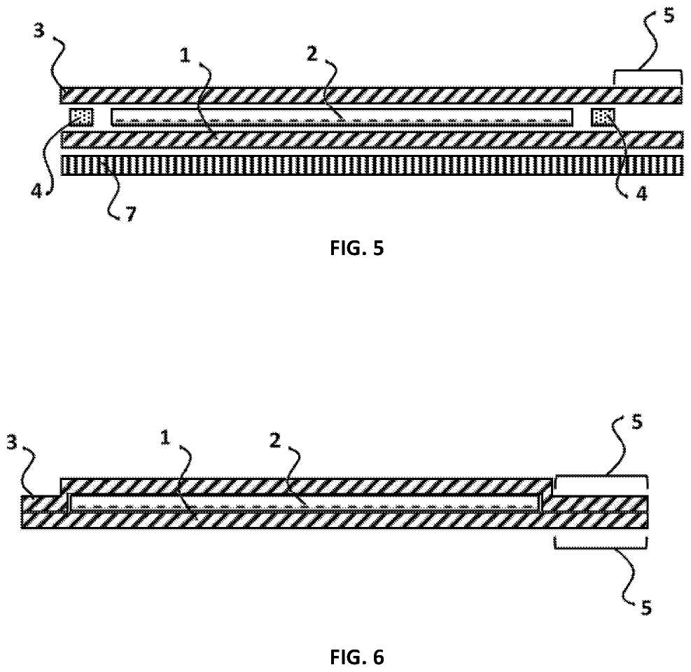

As shown on FIG. 5 an adhesive layer (7) may be applied to the bottom layer's reverse face to which the candle material is applied. That adhesive layer allows for placement of the sampler on a carrier such as a card or a newspaper.

The top layer (3) can be made from the same materials as the bottom layer (1). The top layer may also be treated or coated to aid the adhesion of any adhesive or printing thereto.

The scented candle material (2) is applied directly to the bottom layer in liquid form after melting and diluted if desired with suitable additives (solvents and/or waxes). The solvents may be an organic oil such as isopropyl myristate or isopropyl palmitate or a hydrocarbon such as a paraffinic oil. The waxes may be a paraffinic wax, soy wax, microcrystalline wax such as Vybar 103. The choice of the diluents will depend on the candle wax. The use of additives may assist with the adhesion of the candle on the bottom layer, modify the melting point of the candle and may help the release of the candle volatiles molecules. The percentage of solvents or/and waxes added in the melted candle material can vary and will need to be determined for any scented candle.

The amount of candle/diluent materials which are applied to the bottom layer may be adjusted in accordance with the strength of the scents desired.

The top and bottom layers may be selected to adhere, or to be sealed to one another and form a vapor barrier seal around the area to which the sample of candle material has been applied. However, where this is not the case, an adhesive (4) or similar bonding material needs to be applied, preferably around the area to which the candle material has been applied to the bottom layer (1). It is preferred to provide at least part of the radially outward edge of the sampler as an unbonded edge (5) or tab so that a user may easily pull off the top layer.

The adhesive (4) used to bond the top and the bottom layers together may be a water or solvent base adhesive. A pressure sensitive adhesive such as a polyacrylate adhesive or a hot-melt adhesive may be used for example. In the case of the adhesive use with solvent or water that needs to be removed, it is preferred that the removal step is done before the application of the candle material in order to avoid the contamination of the sample rendition. The use of water base polyacrylic adhesive is preferred.

Printing/images may be added on the bottom layer (1) and/or the top layer (3). The ink can be applied in a separate printing operation from the applying the sample. This printing may be achieved before or after the application of the scented candle material to the bottom layer.

The disclosed sampler is preferably made by applying an adhesive ring (4) around the sample area (2) of the bottom sheet (1) to which a sample of scented candle material is to be applied. Then a top layer (4) is applied over the sample area (2) to form a laminate from which the required sampler discs are cut, by stamping, for example.

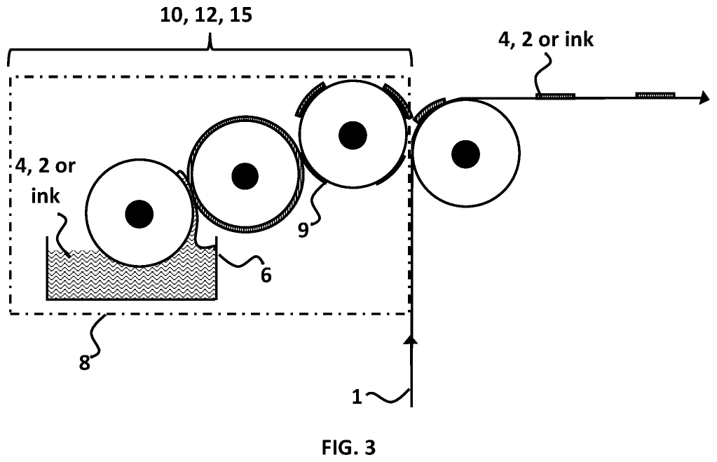

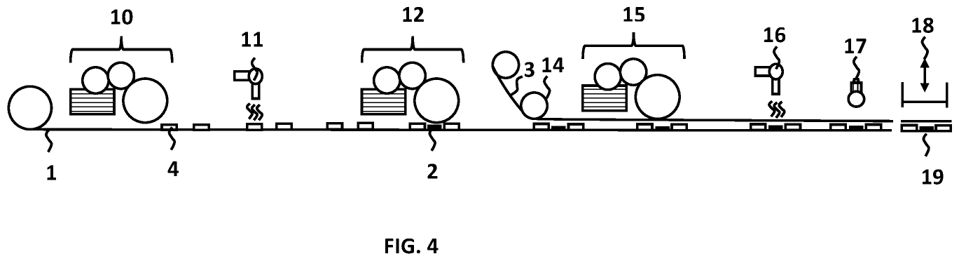

The adhesive (4) is preferably applied to the bottom layer (1) using a conventional sculptured roller applicator (10) shown in FIG. 3. The adhesive may be dried by a hot air blower (11) before the application of the sample of candle material, particularly when the adhesive is a water-based product.

The candle material is preferably melted and diluted in a temperature-controlled bath (6) applied to the bottom layer (1) using a conventional sculptured roller applicator (12) shown in FIG. 3 after the application and drying of the adhesive or ink (on the bottom layer). The rollers are kept in a controlled temperature atmosphere by using a hot tunnel or a hot air blower (8) to avoid the solidification of the waxy material on the rollers and on the pads.

The shape of adhesive and/or candle material application can be defined in function of the pad (9) shape used on the roller. The adhesive and/or candle material may be applied by a non-contact or ink-jet printer technique.

An adhesive (4) and a melted candle material diluted or not (2) are applied on a bottom layer (1) then covered with a top layer by passing the two layers (1) and (3) carrying the adhesive (4) and the candle material through the nip of a pressure roller (14). The top layer (3) can be printed by using a printing unit (15). If necessary, the composite laminate can be heated or dried by a hot air blower (16) or other means to remove residual water or solvent and/or cured by UV light (17).

The top layer may be preprinted before the production of the sampler. In that case, a registration system will be necessary.

The sampler (19) is separated from the composite utilizing a cutter such as a stamp or an air blade cutter (18). Below is an example of the process to make a clear sampler containing a scented candle material.

A commercial scented candle is melted and mixed with an organic oil, isopropyl myristate in a ratio of 4 parts candle material to 1 part organic oil. The hot liquid mixture is then placed in a controlled temperature bath of a roller applicator system.

A water-based adhesive (such as Purethane 20914 Laminating Adhesive from Ashland) is applied in the shape of a rectangular ring to the bottom clear polyester film (coated on the back face by an adhesive and protected by a silicon liner) by using a roller applicator. The adhesive is dried by a hot air blower before the application of the hot, liquid scented candle material by a roller applicator placed in a hot atmosphere by using a hot air blower. The bottom material is then covered by a top treated clear polyester film by passing the two films through the nip of a pressure roller. The sampler is cut by a stamp cutter.

Disclosed is a sampler for a fragrance candle material including a sample of the fragrance candle material applied on a selected area of an upper surface of a bottom layer which is a vapor barrier, a top layer which is a vapor barrio is applied over at least the selected area of the upper surface of the bottom layer, and a seal between the top layer and the bottom layer creating a vapor barrier enclosure for the sample.

The sample can be diluted with compatible additives and solvents as desired. A stabilizer can also be added to the fragrance candle material. And a colored pigment can also be added to the sample of fragrance candle material.

In one embodiment the seal between the top layer and the bottom layer is formed by a ring of adhesive placed beyond at least part of the sample and around the periphery of the upper surface of the bottom layer. In another embodiment the seal between the top layer and the bottom layer is formed by utilizing heat. In all embodiments the seal can be radially inset from the edges of the top and bottom layers for at least part of its length. The bottom layer can be coated to enhance adhesion to the sample.

A process for manufacturing a sampler for a sample of a fragrance candle material includes: selecting a vapor barrier material for a bottom layer of the sampler, selecting a vapor barrier material for a top layer of the sampler, applying a sample on an upper surface of the bottom layer; and sealing the top layer to the bottom layer. The sample can be diluted prior to applying to the upper surface of the bottom layer.

The process may include adding a stabilizer to the sample prior to applying to the upper surface of the bottom layer. In one embodiment of the process the seal is radially inset from the edges of the top and bottom layers for at least part of its length.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

We claim:

1. A sampler for a fragrance candle material comprising:
a sample of the fragrance candle applied on a selected area of an upper surface of a bottom layer wherein the bottom layer is a vapor barrier;
a top layer applied over at least the selected area of the upper surface of the bottom layer wherein the top layer is a vapor barrier; and
a seal between the top layer and the bottom layer wherein the seal creates a vapor barrier enclosure for the sample.

2. A sampler according to claim 1 wherein the sample is diluted with compatible additives.

3. A sampler according to claim 1 wherein the sample is diluted with compatible solvents.

4. A sampler according to claim 3 wherein the solvent is an organic oil.

5. A sampler according to claim 1 wherein a stabilizer is added to the fragrance candle material.

6. A sampler according to claim 1 wherein a colored pigment is added to the fragrance candle material.

7. A sampler according to claim 1 wherein the seal between the top layer and the bottom layer is formed by a ring of adhesive placed beyond at least part of the sample and around the periphery of the upper surface of the bottom layer.

8. A sampler according to claim 1 wherein the seal between the top layer and the bottom layer is formed by utilizing heat.

9. A sampler according to claim 1 wherein the seal is radially inset from the edges of the top and bottom layers for at least part of its length.

10. A sampler according to claim 9 in which at least part of a radially outward edge of the sampler is an unbonded edge.

11. A sampler according to claim 1 further comprising an adhesive layer applied to a lower surface of the bottom layer.

12. A sampler according to claim 1 wherein the bottom layer is coated to enhance adhesion to the sample.

13. A sampler according to claim 1 wherein the solvent is an organic oil.

14. A sampler according to claim 1 wherein the bottom layer and the top layers are made of plastic materials selected to not degrade when sample is applied.

15. A sampler according to claim 1 wherein the bottom layer is a laminate of at least 2 materials.

16. A process for manufacturing a sampler for a sample of a fragrance candle material comprising:
selecting a vapor barrier material for a bottom layer of the sampler;
selecting a vapor barrier material for a top layer of the sampler;
applying a sample on an upper surface of the bottom layer; and
sealing the top layer to the bottom layer.

17. A process for manufacturing a sampler for a sample according to claim 16 wherein the sample is diluted prior to applying to the upper surface of the bottom layer.

18. A process for manufacturing a sampler for a sample according to claim 16 wherein a stabilizer is added to the sample prior to applying to the upper surface of the bottom layer.

19. A process for manufacturing a sampler for a sample according to claim 16 wherein the seal is radially inset from the edges of the top and bottom layers for at least part of its length.

20. A process for manufacturing a sampler for a sample according to claim 19 which at least part of a radially outward edge of the sampler is an unbonded edge.
